(19) United States
(12) Patent Application Publication
(10) Pub. No.: US 2006/0056026 A1
(43) Pub. Date: Mar. 16, 2006

(54) Method for eliminating strong ambient light in aircraft cockpits

(76) Inventors: Aleksandra Kolosowsky, Phoenix, AZ (US); Teddy J. Wood, Corrales, NM (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/155,137

(22) Filed: Jun. 16, 2005

Related U.S. Application Data
(63) Continuation-in-part of application No. 10/123,811, filed on Apr. 16, 2002, now Pat. No. 6,909,544.

(51) Int. Cl. G02B 5/30; G02B 27/28

(52) U.S. Cl. 359/497

(57) ABSTRACT

Light is polarized in perpendicular directions between a source of light and a users viewing of information on a display device. A first sheet of polarized material is placed at the source of the light, such as a window in a cockpit. A second sheet of polarized material is attached or integral to a display device. The pass axis of the second sheet is oriented substantially perpendicular to pass axis of the first sheet. Additionally, the same methodology can be used to minimize reflections from cockpit displays at night.

### CROSS REFERENCE TO RELATED APPLICATIONS

This application is a continuation-in-part application of U.S. Pat. No. 6,909,544, entitled “Device For Eliminating Strong Ambient Light in Aircraft”, filed Apr. 16, 2002, which is herein incorporated by reference in its entirety.

### BACKGROUND OF THE INVENTION

1. Field of the Invention (Technical Field)

The present invention relates to display devices, and in particular to the use of two polarizers to ensure visibility outside of the cockpit world from inside the cockpit by minimizing reflected images of avionic displays on the aircraft canopy.

2. Background Art

Display devices, such as liquid crystal displays (LCDs) and cathode ray tubes (CRTs) are used to display data to users. Aircraft are used in both day and night conditions. Bright environments, such as cockpits of aircraft often contain such display devices. In some environments, the visibility of information is critical. In aircraft, good visibility of the information on display devices can be critical to safe operation of the aircraft. In dark conditions, it is important that the outside environment be visible through the aircraft canopy as well. Reflections of the cockpit displays on the canopy must be minimized to ensure good visibility through the canopy or the cockpit window.

Prior solutions for minimizing the effect of cockpit ambient light include application of various films or coatings only to display surfaces. Coatings such as AR, AG, and linear or circular polarizers work under low or moderate ambient light conditions, but fail at higher levels of illuminance, such as 10K foot candles.

To minimize canopy reflections, the light from the display is usually directed toward the pilot as much as possible. Mechanical filters are sometimes used which are constructed from micro-louvers which act like Venetian blinds to limit light to very specific angles. The mechanical filters can have negative effects such as low transmission and can cause interference patterns (moire) between the display pixel array and the micro-louver pitch.

There is a need for enhanced visibility of information on display devices in bright environments and minimizing reflections from the cockpit windows or the canopy at night.

### SUMMARY OF THE INVENTION (DISCLOSURE OF THE INVENTION)

Light is polarized in perpendicular directions between a source of light and a user's viewing of information on a display device. In one embodiment, a first polarized material is placed at the source of the light, such as a side window in a cockpit. A second polarized material is positioned proximate a display device, or attached with an adhesive. The projected polarization pass axis of the first polarized material is oriented substantially perpendicular to polarization pass axis of the second polarized material.

Or conversely, light is polarized in perpendicular directions between a source of light and a user viewing outside of the cockpit through a window or canopy. In one embodiment, a first polarized material is placed at the source of the light, such as a display in a cockpit. A second polarized material is positioned proximate to the cockpit side window or canopy, or attached with an adhesive. The projected polarization pass axis of the first polarized material is oriented substantially perpendicular to polarization pass axis of the second polarized material

In one embodiment, the first polarized material comprises a first sheet of polarized material with an adhesive on one side, and is placed directly on a side window comprising the source of bright light. In a further embodiment, the first sheet comprises a shade that can be moved to cover the window in a repeatable manner, like a pull down shade configuration, or an electro optical device such as a switchable polarizing window.

In further embodiments, the display device comprises a LCD display that is manufactured with an integrated polarizer. The first sheet of polarizing material is then attached with a polarization pass axis orientation substantially perpendicular to that of the integrated polarizer. Such an orientation is easily obtained by simply moving the first sheet of polarizing material to a position that substantially minimizes the effect of light on the display device. This orientation will also minimize reflections of the LCD on the canopy or window when the external ambient light is very low.

When a CRT display is utilized, the second polarized material comprises a second sheet of polarizing material comprises a separate transparent material which is properly positionable proximate the CRT to minimize reflection from bright ambient light. This orientation will also minimize reflections of the CRT on the canopy or window.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a block representation of a pair of polarizing sheets in a cockpit having a display device.

FIG. 2 is a block representation of an alternative embodiment of a cockpit having a display device.

FIG. 3 shows the alternative embodiment of the invention for minimizing reflections from cockpit displays.

### DESCRIPTION OF THE PREFERRED EMBODIMENTS (BEST MODES FOR CARRYING OUT THE INVENTION)

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

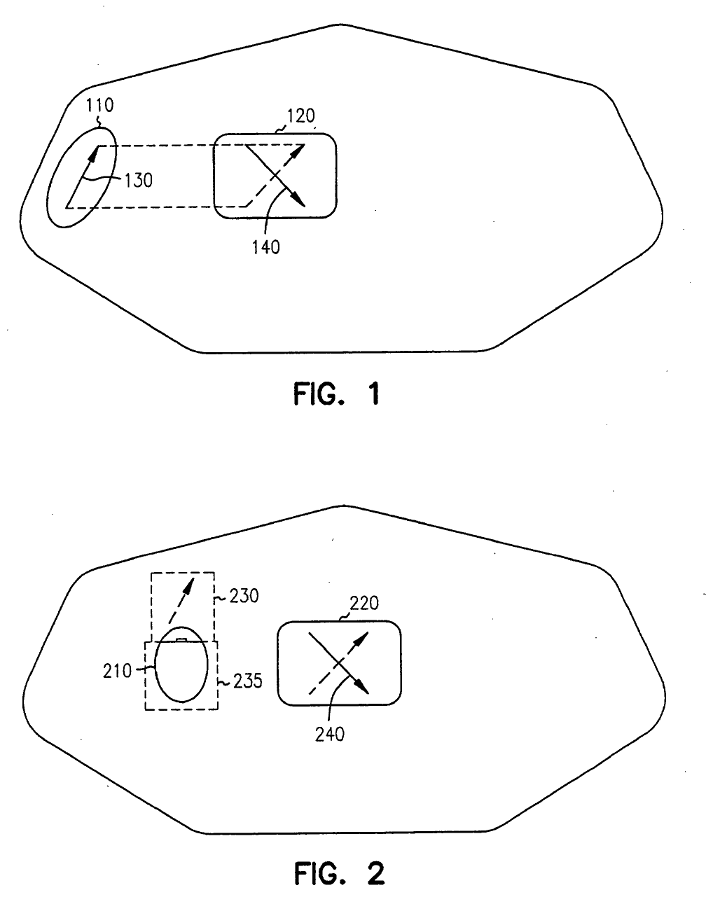

FIG. 1 is a block diagram of a cockpit having a light source 110, such as a window, and a display device 120, which receives ambient light from light source 110. In prior systems, the ambient light would overwhelm the visibility of information viewable on the display device. In the present invention, a first sheet of polarizing material 130, represented by an arrow is attached to the window 110. The arrow on material 130 also approximately represents the pass axis orientation of the polarizing material. A second sheet of polarizing material 140, represented by an arrow is attached to the display screen 120. The arrow on material 140 represents the pass axis orientation of the polarizing material, and is projected substantially perpendicular or orthogonal to projected light from the pass axis of material 130. The actual angle of the pass axis of each polarizing material is dependent on the geometry of the cockpit.

Each side window proximate an environment containing a display is provided with a sheet of polarizing material having a pass axis orientation projected approximately perpendicular to that of the polarization on the display. The polarizer in one embodiment is a high-transmittance, high-efficiency polarizer and is available from several manufacturers, such as Polaroid and Nitto. The polarizer also contains a pressure sensitive adhesive to enable easy attachment to the surface. In further embodiments, an electro optical device provides the proper polarization, such as a switchable polarizing window.

The display device comprises an active display device that is self-contained and directly provides an image to the user, such as a LCD display or CRT display. LCD displays are manufactured with an integrated polarizer. The first sheet of polarizing material is then attached with a polarization pass axis orientation substantially perpendicular to that of the integrated polarizer. Such an orientation is easily obtained by simply moving or rotating the first sheet of polarizing material to a position that substantially minimizes the effect of ambient light on the display device.

When a CRT display is utilized, the second sheet of polarizing material comprises a separate transparent material which is properly positionable proximate the CRT such as attached to the cover glass to substantially minimize or reduce ambient reflection from bright light such that information on the CRT is easily viewable.

In FIG. 2, a cockpit is shown, but is representative of many other environments having high ambient light conditions such as that caused by a bright source of light, such as a window 210. The cockpit also contains display devices 220. In this embodiment, the first sheet of polarized material is in the form of a shade 230, which is similar to opaque shades on commercial aircraft that passengers use to totally block sunlight. Shade 230, however, is polarized material, having a polarization oriented as previously described. The material, such as a sheet, is affixed or adhered to Plexiglas or other transparent material to provide rigidity. The sheet is pulled down in tracks 235 proximate to the window to cover the window when ambient light in the cockpit is interfering with information on the display. The display also comprises a sheet of polarizing material 240 or other polarization mechanism, which operates in conjunction with shade 230 to block a significant portion of the light from interfering with information on the display.

A display viewing room such as cockpit has a side window or other structure through which strong ambient light enters the room. A first polarizing sheet is positioned proximate the window. The room also contains a display device for conveying information to a user. A second polarizing sheet is positioned proximate to the display. The polarizing sheets have pass axis orientations substantially perpendicular to each other to significantly reduce or eliminate ambient reflection on the display. In addition, at night, reflections of the display on the canopy or window will be substantially reduced.

The polarizing sheets are alternatively in the form of retractable shades. The shades are moveable from a first position covering the display or window to a second position not covering the display or window. The shades may be positioned near or proximate the window or display to reduce ambient reflection. In some embodiments, the shades are positioned very close to the window or display, and in other embodiments close enough to the display or window to ensure that a significant amount of the light passes through both polarizing sheets prior to reaching a user.

A method of reducing the effect of ambient light on a display is performed by placing a first polarizing material proximate a display having a first pass axis orientation. A second polarizing material is placed proximate a source of ambient light. The second material has a second pass axis substantially perpendicular to the first pass axis. One of the polarizing materials is rotated to minimize the affect of the ambient light on visibility of information on the display. Where there are multiple ambient light sources and multiple displays, care should be taken to consistently align the pass axis of each sheet. In addition, reflections of the display image from the window or canopy will be substantially reduced at night when little or no external light is present.

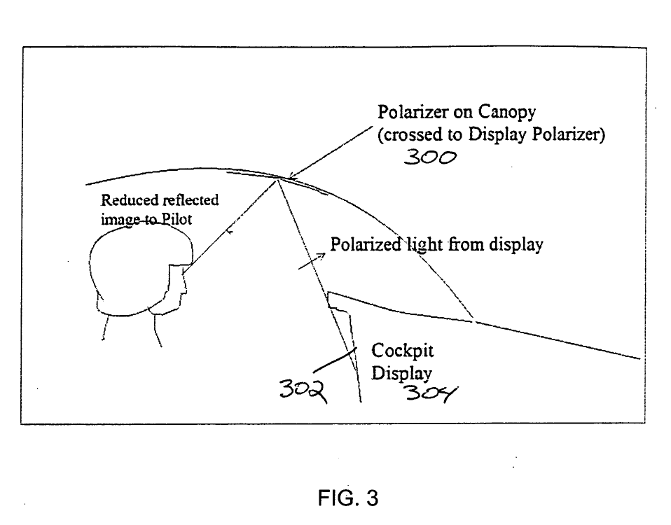

Another embodiment is shown in FIG. 3. In this embodiment, reflections from the cockpit displays 304 are minimized. The polarizer locations are the same as in the above description. In this embodiment, the external light passes through the first polarizer 300 on the cockpit canopy and then striking the second polarizer 302 on the display 304. Since the first polarizer 300 is crossed to the second polarizer 302, the reflection of the external light source from the displays 304 is greatly reduced.

At night, the external surrounding of the cockpit is very dark relative to the lighting inside the cockpit. The canopy of most fighter cockpits has coatings which make them fairly reflective (5-10%). Aircraft manufacturers try to cover the displays with glareshields as much as possible to minimize canopy reflections. However, not all displays can be covered. The light from the displays will reflect from the canopy with fairly high contrast since the surrounding night sky is relatively dark.

The reflections from the cockpit displays from the aircraft canopy can be greatly reduced by the same crossed polarizer configuration. The light coming from the display passes through the 2nd polarizer (on the display). The first polarizer, located on the inside of the canopy is crossed to the second polarizer. The reflected image of the display from the canopy is greatly reduced by the first polarizer. Linear or circular polarizers may be used to minimize the reflection.

Therefore the same construction for improvement of full daylight performance can be used to greatly reduce the effects of canopy reflections in night operations.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

1. An apparatus for minimizing reflections of displays from a window, the apparatus comprising:
a first polarizer disposed on an inside of the window; and
a second polarizer disposed on said displays, said first polarizer comprising a pass axis orientation substantially perpendicular to said second polarizer,

2. The apparatus of claim 1 wherein said first and second polarizer comprise linear polarizers.

3. The apparatus of claim 1 wherein said first and second polarizer comprise circular polarizers.

4. The apparatus of claim 1 wherein said window comprises an aircraft canopy.

5. The apparatus of claim 1 wherein said displays comprise cockpit displays.

6. A method of minimizing reflections of at least one display from a window, the method comprising:
a) affixing a first polarizer to an inside of the window; and
b) affixing a second polarizer to the at least one display, the first polarizer having a pass axis orientation substantially perpendicular to a pass axis orientation of the second polarizer.

7. The method of claim 6 wherein the first and second polarizer comprise linear polarizers.

8. The method of claim 6 wherein the first and second polarizer comprise circular polarizers.

9. The method of claim 6 wherein the step of affixing a first polarizer comprises affixing the first polarizer to a canopy of an aircraft.

10. The method of claim 6 wherein the step of affixing a second polarizer comprises affixing the second polarizer to at least one cockpit display.
